(19) United States
(12) Patent Application Publication
(10) Pub. No.: US 2007/0127264 A1
(43) Pub. Date: Jun. 7, 2007

(54) SURFACE EMITTING DEVICE

(75) Inventors: Takuro Sugiura, Fukushima-ken (JP); Hideaki Nagakubo, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/549,512

(22) Filed: Oct. 13, 2006

(30) Foreign Application Priority Data
Oct. 18, 2005 (JP) 2005-303267

(51) Int. Cl. F21V 7/04

(52) U.S. Cl. 362/613

(57) ABSTRACT

A surface emitting device is provided. The surface emitting device includes a plurality of light sources; at least one light guide member; and a plurality of prisms that are disposed on the main surfaces of the light guide member corresponding to the light sources that are formed by convex-concave portions and change the optical path of light from the light sources toward the display surface. The surface emitting device is operable to display only light from the prism corresponding to a turned-on light source.

This patent document claims the benefit of Japanese Patent Application 2005-303267 filed Oct. 18, 2005, which is hereby incorporated by reference.

### BACKGROUND

1. Field

The present embodiments relate to a surface emitting device.

2. Related Art

A light guide member has been used for various purposes, for example, in a backlight device serving as an illumination unit of a liquid crystal display device. The backlight device has a light source, a light guide plate that emits light from the light source to a liquid crystal display panel, and a prism that efficiently supplies light from the light guide plate to the liquid crystal display panel. The light guide plate is in a flat plate shape, and has a pair of main surfaces facing each other and a pair of end surfaces facing each other. In this case, the liquid crystal display panel is disposed on one of the main surfaces, and the light source is disposed in the vicinity of one of the end surfaces. A reflecting plate is disposed on the other main surface so as to reflect light from the light source.

Generally, the light guide plate has a light-emission display function by forming convex-concave portions (prisms) in various shapes on the main surface of the light guide plate.

For example, in JP-A-2004-325179, discloses an on-vehicle display device that uses a light guide plate as a light-emission display device. In the on-vehicle display device, a first display design portion and a second display design portion are formed on one main surface of the light guide plate that forms a dial plate. The first display design portion is formed in a convex-concave shape and changes the optical path of light from a first light source so as to form scales or the like. A second display design portion is formed in a convex-concave shape and changes the optical path of light from a second light source so as to form, for example, numerals. As the first light source is turned on, the first display design portion performs light-emission display. As the second light source is turned on, the second display design portion performs light-emission display.

In the display device disclosed in JP-A-2004-325179, the first display design portion and the second display design portion form individual display regions. As the first and second light sources are turned on at one time or are individually turned on, the first display design portion and the second display design portion independently perform light-emission display at different portions within the same display surface. Display regions for the first display design portion and the second display design portion are separately provided within the same surface so as not to overlap each other.

If different kinds of display are performed in separate regions, the area of the total display region increases. When the display device is mounted on an apparatus, for example, a cellular phone, it is difficult to achieve a reduction in size. When different kinds of display are displayed at one time in separate regions, information may be scattered and lack unity according to the usages, which causes deterioration in convenience of the apparatus, on which the display device is mounted. Accordingly, a compact surface emitting device that can selectively display various kinds of information on the same display surface while reducing the size of the display surface is desired.

### SUMMARY

In one embodiment, a surface emitting device includes a plurality of light sources, at least one light guide member that has an end surface receiving light from the light sources and a pair of main surfaces facing each other. The surface emitting device outputs light received from the light sources through the end surface from one of the mains surfaces toward a predetermined display surface. A plurality of prisms that are disposed on the main surfaces of the light guide member corresponding to the light sources, are formed by convex-concave portions having predetermined patterns. The plurality of prisms change the optical path of light from the light sources toward the display surface. As one of the light sources is selectively turned on, only light from the prism corresponding to the turned-on light source is output toward the display surface.

In this embodiment, as one of the light sources is selectively turned on, only the light from the prism corresponding to the turned-on light source is output toward the display surface, and light-emission regions of the individual prisms partially overlap each other. Accordingly, the area of the total display region is suppressed small. As a result, when the display device is mounted on an apparatus, for example, a cellular phone, the size of the apparatus can be reduced. Different kinds of display are selectively displayed on the same display surface, for example, a display pattern on the display surface can be changed by switching the light sources that are turned on by switching modes. It is possible to easily and clearly display information, without causing scattering of information, and thus to improve convenience of information. In one embodiment, a compact surface emitting device selectively displays various kinds of information on the same display surface while reducing the size of the display region.

The number of the light guide members is not limited to one, and the number of the display surface to which light from the light guide member is directed is not limited to one. For example, if the number of the light guide members is more than one, a display surface can be provided for each light guide member or a common display surface can be provided for the light guide members. Alternatively, a plurality of display surfaces can be provided for one light guide member. The directions in which the optical path of light from the prisms is changed may be equal or unequal. The light-emission regions of light of the prisms may overlap each other.

In the surface emitting device according to one embodiment, the light guide member includes a first end surface that receives light from a first light source. A second end surface is disposed to face the first end surface and receives light from a second light source. A first prism is disposed on a first main surface. A second main surface is disposed so as to face the first main surface and on which a second prism is disposed. The first prism receives light from the first light source and changes the optical path of light toward the second main surface. The second prism receives light from the second light source and changes the optical path of light toward the first main surface.

The light guide plate can perform light-emission display of the prisms on both sides of the light guide plate. One light guide plate can perform two kinds of light-emission display (two kinds of light-emission display corresponding to each pattern of the first and second prisms). A multifaceted display can be performed, and the entire thickness of the surface emitting device is reduced in size.

According to one embodiment, the first and second prisms may have convex-concave portions that are substantially formed in an inequilateral triangle having a first slope portion and a second slope portion alternately disposed. The first slope portion may be inclined at a predetermined first angle with respect to the main surface, and the second slope portion may be inclined at a second angle larger than the first angle with respect to the main surface. The second slope portion may receive light from the light sources and change the optical path of light.

While the second slope portion efficiently changes the optical path of light from the light sources, light in a normal direction can be transmitted by the second slope portion. It is possible to easily and clearly perform light-emission display of complex and delicate patterns of the prisms.

In one embodiment, a light receiving surface of the second slope portion of the first prism may face the first end surface. A light receiving surface of the second slope portion of the second prism may face the second end surface opposite to the light receiving surface of the second slope portion of the first prism.

The optical path of light can be changed as the light from each light source is reliably incident on the corresponding prism (light from one of the light sources is prevented from being incident on the plurality of prisms). A switch of light-emission display patterns can be reliably performed according to a switch of the light sources.

In one embodiment, a reflecting member is disposed so as to face the first main surface or the second main surface. As the reflecting member reflects light from the first or second prism, the first and second prisms output light toward a common display surface, and output light-irradiated regions on the display surface partially overlap each other.

In one embodiment, the light guide plate can selectively perform light-emission display of each prism on one side of the light guide plate. For example, two kinds of light-emission display (two kinds of light-emission display corresponding to the patterns of the first and second prisms) can be performed. Since one light guide plate can simply perform two kinds of light-emission display, multifaceted display can be performed, and the entire thickness of the surface emitting device can be reduced in size.

In the surface emitting device according to the aspect of the invention, a slope angle of the first slope portion of the first or second prism may be set such that the first slope portion transmits light reflected by the reflecting member.

According to one embodiment, light in a normal direction is reliably transmitted by the first slope portion. Accordingly, even though the reflecting member reflects light from the first prism toward the second prism, the light-emission pattern of the first prism is not affected by the second prism. Even though the first and second prisms are formed in one light guide plate, it is possible to easily and clearly perform light-emission display of complex and delicate patterns of the prisms.

In one embodiment, the light guide member may have a first light guide member and a second light guide member. The first light guide plate may receive light from the first light source at the end surface, and may have the first prism that changes the optical path of light from the first light source. The second light guide plate may receive light from the second light source at the end surface, and may have the second prism that changes the optical path of light from the second light source.

Since one light guide plate individually corresponds to one light source and one prism, it is possible to make simple a manufacturing process, and clearly distinguish from which light source light comes from, and release limitation on shape patterns of the prisms, thereby achieving a prism pattern having a high degree of freedom.

The first light source may emit a predetermined first color, and the second light source may emit at least one color other than the first color.

### BRIEF DESCRIPTION OF THE DRAWINGS

FIG. 1A is a plan view of a first main surface of a light guide plate;

FIG. 1B is a side view of the light guide plate; FIG. 1C is a plan view of a second main surface of the light guide plate;

FIG. 2A is a plan view that illustrates a light-emission pattern of a prism as viewed from the first main surface;

FIG. 2B is a side view of a light guide plate;

FIG. 3 is a conceptual view that illustrates a state where the optical path of light from the light source is changed at the prism of the light guide plate;

FIG. 4A is a view showing a display pattern during non-illumination when the light source is turned off;

FIG. 4B is a view showing a display pattern during illumination when the light source is turned on;

FIGS. 5A to 5F are views showing various display patterns of the prism;

FIG. 6A is a plan view of the first main surface of the light guide plate;

FIG. 6B is a side view of the light guide plate;

FIG. 6C is a plan view of the second main surface of the light guide plate;

FIG. 7A is a side view of a light guide plate;

FIG. 7B is a plan view showing a light-emission pattern of the first prism as viewed from the second main surface;

FIG. 7C is a perspective view of a surface emitting device having the light guide plate of FIG. 6;

FIG. 8A is a plan view showing a light-emission pattern of the second prism as viewed from the first main surface;

FIG. 8B is a side view of the light guide plate;

FIG. 8C is a perspective view of a surface emitting device having the light guide plate of FIG. 6;

FIG. 9 is a perspective view of a surface emitting device according to a second embodiment of the invention;

FIG. 10A is a plan view showing a light-emission pattern of the first prism as viewed from the first main surface;

FIG. 10B is a side view of the light guide plate;

FIG. 10C is a perspective view of a surface emitting device;

FIG. 11A is a plan view that shows a light-emission pattern of the second prism as viewed from the first main surface;

FIG. 11B is a side view of the light guide plate;

FIG. 11C is a perspective view of a surface emitting device;

FIG. 12 is a view showing switch of display patterns according to a first application of the second embodiment;

FIG. 13 is a view showing switch of display patterns according to a second application of the second embodiment;

FIG. 14 is an exploded perspective view of the surface emitting device according to the second embodiment (when the first light source emits light); and

FIG. 15 is an exploded perspective view of the surface emitting device according to the second embodiment (when the second light source emits light).

### DETAILED DESCRIPTION

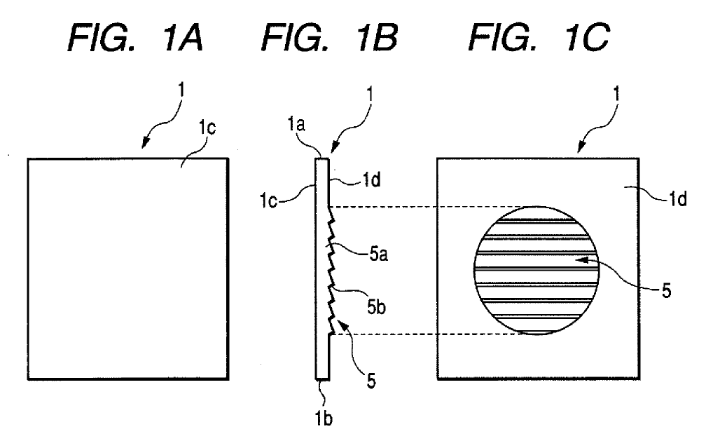

As shown in FIGS. 1A to 1C, a light guide plate 1 serves as a light guide member that constitutes a surface emitting device formed of a transparent member, and has a pair of first and second end surfaces 1a and 1b and a pair of a first and second main surfaces 1c and 1d. The first and second end surfaces 1a and 1b can receive light from a light source (not shown) and face each other. The first and second main surfaces 1c and 1d are orthogonal to the end surfaces 1a and 1b and face each other. Light from the light source that enters the end surfaces 1a and 1b can be output from one of the main surfaces 1c and 1d toward a predetermined display surface (not shown).

A prism 5 is formed in a circular convex-concave shape on one main surface (the second main surface 1d in FIG. 1C) of the light guide plate 1. The prism 5 changes the optical path of light from a light source that is introduced by the light guide member 1 toward the other main surface (the first main surface 1c in FIG. 1A) or a display surface (not shown) that is disposed to face the other main surface 1c.

As shown in FIG. 3, the prism 5 has a convex-concave portion that is formed substantially in an inequilateral triangle having a gentle slope surface 5a and a steep slope surface 5b alternately disposed. The gentle slope surface 5a is inclined at a predetermined first angle θ1 with respect to the main surface 1d, and the steep slope surface 5b is inclined at a second angle θ2 larger than the first angle θ1 with respect to the main surface 1d.

A light receiving surface 8 of the steep slop portion 5b receives light L1 from the light source that is introduced by the light guide plate 1 and changes the optical path of light. In this case, the light receiving surface 8 of the steep slope surface 5b faces one end surface (the first end surface la in FIGS. 1B and 3), and can efficiently change the optical path of light from the light source that is incident on the end surface with respect to the other main surface (the first main surface 1c in FIG. 1B). In one embodiment, the slope angle θ1 of the gentle slope surface 5a is set such that the gentle slope surface 5a transmits light L2 in a normal direction (in a vertical direction with respect to the main surfaces 1c and 1d) (for example, 2.5°). The light guide member 1 having the prism 5 can be manufactured by injection molding.

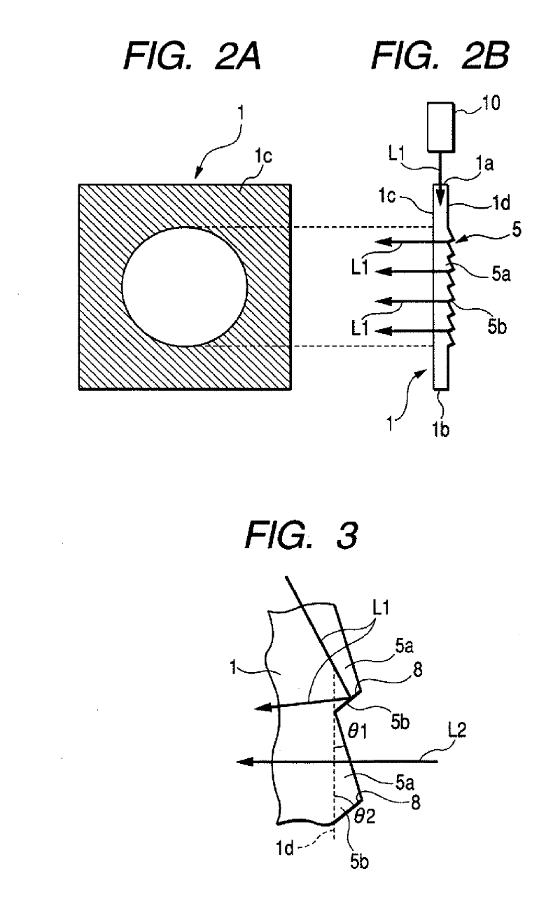

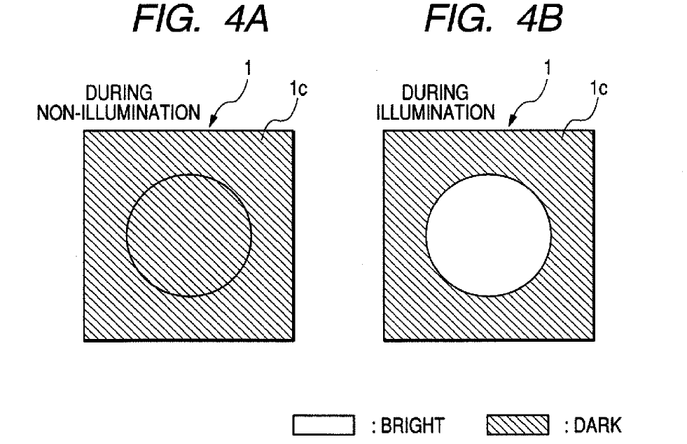

FIGS. 2A and 2B are views showing the light guide plate 1 having the configuration of FIG. 1 in which a light source 10 is disposed to face the first end surface 1a. As shown in FIGS. 2A and 2B, as the optical path of the light L1 output from the light source 10 is changed by the light receiving surface 8 of the steep slope surface 5b of the prism 5 formed on the second main surface 1d, light goes toward the first main surface 1c (see FIG. 3). When a light-emission pattern of the prism 5 is viewed from the first main surface 1c (for example, through a display surface disposed to face the first main surface 1c), the pattern is viewed as a circular shape as shown in FIG. 2A. For example, as shown in FIGS. 4A and 4B, during illumination, when the light source 10 is turned on, a circular light-emission pattern can be observed from the first main surface 1c, as shown in FIG. 4B.

During non-illumination, when the light source 10 is turned off, a display pattern becomes dark as viewed from the first main surface 1c, as shown in FIG. 4A (a diagonal line portion indicates a dark region, and a non-diagonal line portion indicates a bright region in FIGS. 2A and 2B, and 4A and 4B).

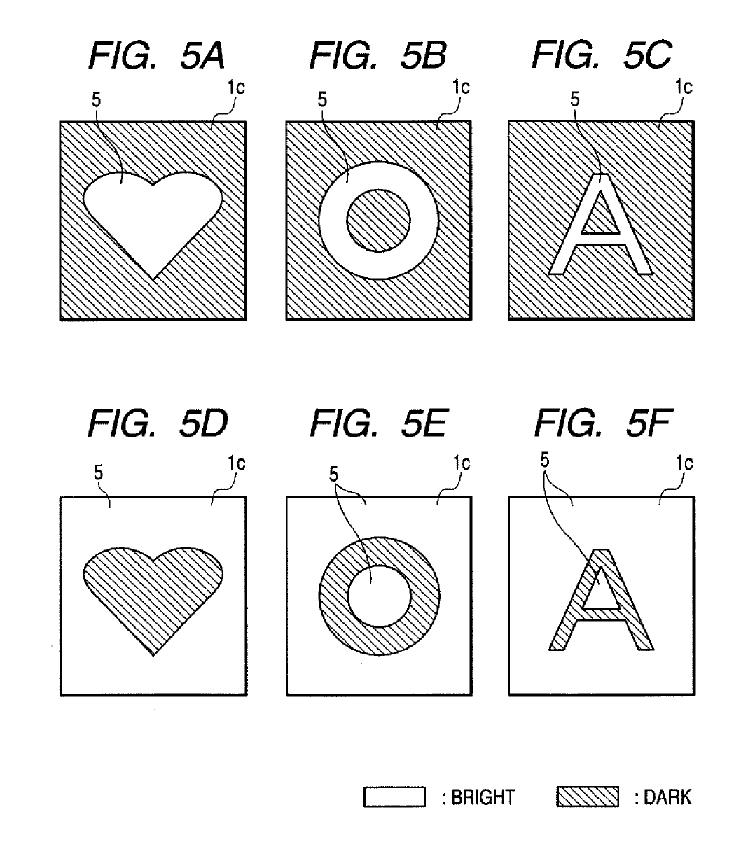

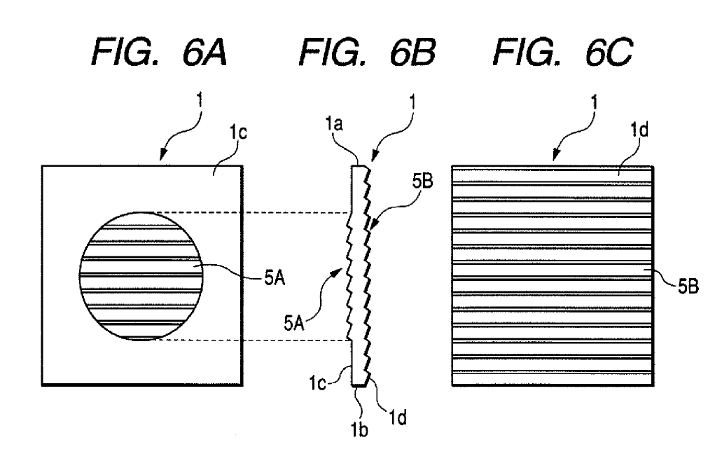

FIGS. 5A to 5F are views showing applications of patterns of the prism 5. The prism 5 has a circular pattern when the principle is described in FIGS. 1A to 4B, but the prism 5 has various patterns, in addition to the circular shape, in FIGS. 5A to 5F (for example, a heart shape in FIGS. 5A and 5D, a circular ring shape in FIGS. 5B and 5E, and an alphabet A shape in FIGS. 5C and 5F). As shown in FIGS. 5A to 5C, in order to achieve a desired display pattern, the prism 5 (the bright region) can be formed in the desired display pattern (the desired display pattern can be displayed brightly by partially forming the prism 5 in the light guide plate 1).

Alternatively, as shown in FIGS. 5D to 5F, a prism is formed in a shape excluding a display shape in order that a region (dark region) except the prism 5 is formed in a desired display pattern (as some of the light guide plate 1 are not provided with the prism 5, the desired display pattern can be displayed dark).

As described above, the prism 5 may have various geometrical patterns. The patterns are not limited to figures, for example, the patterns may include any desired shapes, such as characters and numerals.

Since the light guide plate 1 is transparent, the light guide plate 1 is placed on, for example, drawings, characters, or pictures and illumination can be partially applied to them. As the light guide plate 1 is complicatedly superimposed, illumination patterns on the same surface can be changed.

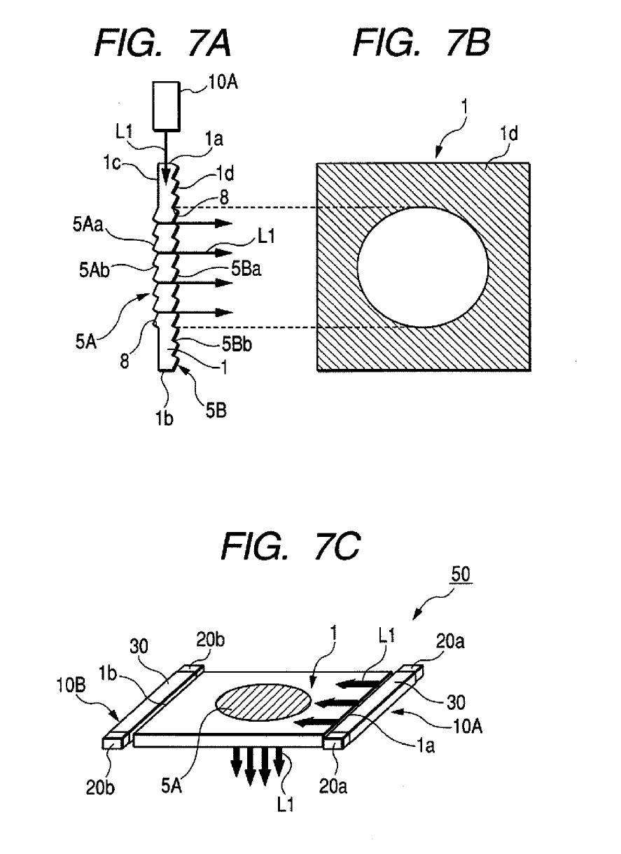

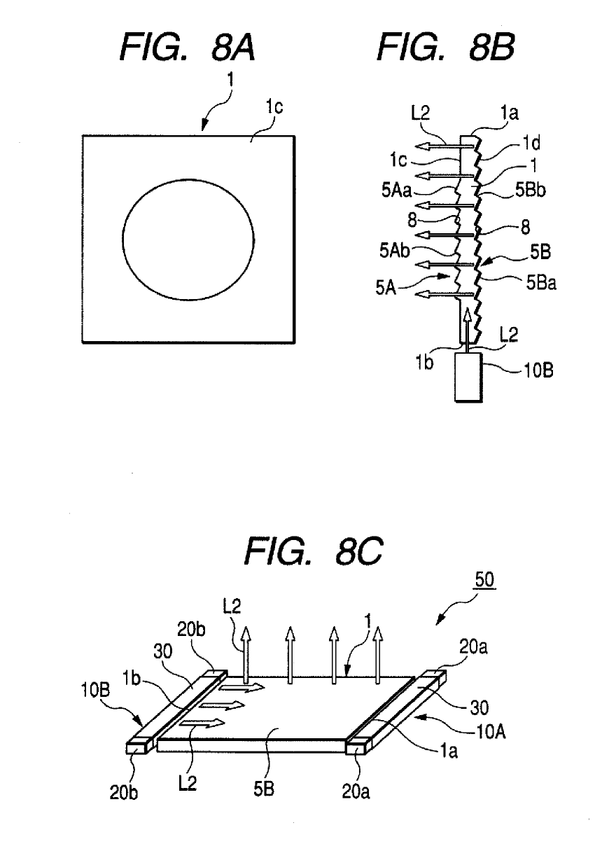

As shown in FIGS. 7C and 8C, a surface emitting device 50 according to one embodiment has the light guide plate 1, and first and second light sources 10A and 10B that are disposed to face the first and second end surfaces 1a and 1b of the light guide plate 1. In this embodiment, the first light source 10A has a linear light guide plate 30 disposed along the first end surface 1a of the light guide plate 1, and LEDs 20a and 20a that are disposed at both ends of the linear light guide plate 30 to selectively irradiate blue light and red light.

In one embodiment, the light guide plate 1 includes the first end surface la that receives light from the first light source 10A, the second end surface 1b that is located to face the first end surface 1a and receives light from the second light source 10B, the first main surface 1c on which a first prism 5A is disposed, and the second main surface 1d on which a second prism 5B is disposed.

The first prism 5A is formed in a circular shape at the center of the first main surface 1c. The first prism 5A has a convex-concave portion that is substantially formed in an inequilateral triangle having a gentle slope surface 5Aa and a steep slope surface 5Ab alternately disposed. The gentle slope surface 5Aa is inclined at a predetermined first angle θ1 with respect to the first main surface 1c, and the steep slope surface 5Ab is inclined at a second angle θ2 larger than the first angle θ1 with respect to the first main surface 1c. The light receiving surface 8 of the steep slope portion 5Ab receives light L1 from the first light source 10A that is introduced by the light guide plate 1 to change the optical path of light toward the second main surface 1d.

The second prism 5B is formed on the entire second main surface 1d. The second prism 5B has a convex-concave portion that is substantially formed in an inequilateral triangle having a gentle slope surface 5Ba and a steep slope surface 5Bb alternately disposed. The gentle slope surface 5Ba is inclined at a predetermined first angle θ1 with respect to the second main surface 1d, and the steep slope surface 5Bb is inclined at a second angle θ2 larger than the first angle θ1 with respect to the second main surface 1d. The light receiving surface 8 of the steep slop portion 5Bb receives light L2 from the second light source 10B that is introduced by the light guide plate 1 to change the optical path of light toward the first main surface 1c.

According to this embodiment, the light receiving surface 8 of the steep slope surface 5Ab of the first prism 5A faces the first end surface 1a, while the light receiving surface 8 of the step slope surface 5Bb of the second prism 5B faces the second end surface 1b opposite to the light receiving surface 8 of the steep slope surface 5Ab of the first prism 5A.

In the surface emitting device 50 having the above configuration, as one of the two light sources 10A and 10B is selectively turned on, light comes from the prism 5A or 5B corresponding to the turned-on light source 10A and 10B. For example, as shown in FIGS. 7A and 7B, when the first light source 10A is turned on, the light receiving surface 8 of the steep slope surface 5Ab of the first prism 5A formed on the first main surface 1c changes the optical path of light L1 output from the first light source 10A, such that light goes toward the second main surface 1d and passes through the gentle slope surface 5Ba of the second prism 5B. Therefore, when a light-emission pattern of the first prism 5A is viewed from the second main surface 1d (for example, through the display surface that is disposed to face the second main surface 1d), the pattern is viewed as a circular shape, as shown in FIG. 7B.

When the second light source 10B is turned on, as shown in FIG. 8, the light receiving surface 8 of the steep slope surface 5Bb of the second prism 5B formed on the second main surface 1d changes the optical path of light L2 output from the second light source 10B, such that that light goes toward the first main surface 1c and passes through the gentle slope surface 5Aa of the first prism 5A. A light-emission pattern of the second prism 5B is viewed from the first main surface 1c (for example, through the display surface that is disposed to face the first main surface 1c), the pattern is viewed as if the entire surface emits light, regardless of its shape. In this respect, according to this embodiment, the light-emission regions of the prisms 5A and 5B partially overlap each other.

When both light sources 10A and 10B are turned off, as described above with reference to FIG. 4A, the display pattern becomes dark as viewed from the first and second main surfaces 1c and 1d. In order to allow the light-emission portion to emit light more uniformly, a diffusion sheet can be used so as to diffuse light on the emitting surface.

According to this embodiment, as one of the light sources 10A and 10B is selectively turned on, only light from the prism 5A or 5B corresponding to the turned-on light source is output toward the display surface, and the light-emission regions of the prisms 5A and 5B partially overlap each other. It is possible to suppress the area of the total display region. As a result, when the display device is mounted on an apparatus, for example, a cellular phone, the size of the apparatus is reduced.

According to this embodiment, the light guide plate 1 can perform light-emission display of the prisms 5A and 5B on both sides of the light guide plate 1. One light guide plate 1 can perform two kinds of light-emission display (two kinds of light-emission display corresponding to the patterns of the first and second prisms 5A and 5B). A multifaceted display is performed and the entire thickness of the surface emitting device 50 is reduced.

According to this embodiment, the steep slope surfaces 5Ab and 5Bb can efficiently change the optical path of light from the light sources 10A and 10B, and light in a normal direction can be transmitted by the gentle slope surfaces 5Aa and 5Ba. Accordingly, it is possible to easily and clearly perform light-emission display of complex and delicate patterns of the prisms 5A and 5B.

According to this embodiment, the light receiving surface 8 of the steep slope surface 5Ab of the first prism 5A faces the first end surface 1a, and the light receiving surface 8 of the steep slope surface 5Bb of the second prism 5B faces the second end surface 1b opposite to the light receiving surface 8 of the steep slope surface 5Ab of the first prism 5A. The optical path of light can be changed as the light from each light source 10A and 10B is reliably incident on the corresponding prism 5A and 5B (light from one of the light sources 10A and 10B is prevented from being incident on the plurality of prisms 5A and 5B), and switch of light-emission display patterns can be reliably performed in accordance with the switch of the light sources 10A and 10B.

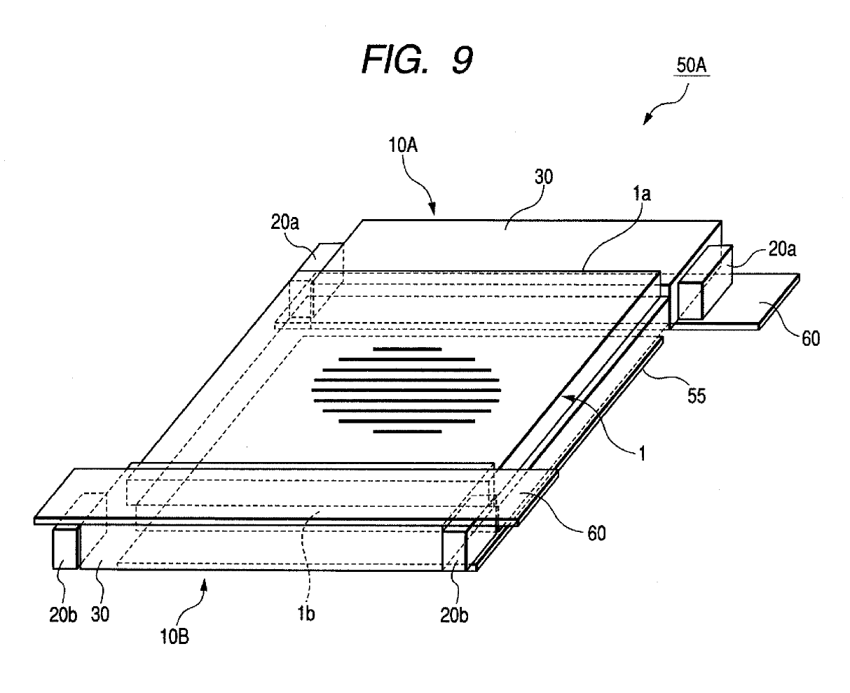

FIGS. 9 to 11 are views showing a second embodiment of the invention to which the principle of FIGS. 1 to 4 is applied. Since the second embodiment is a modification of the first embodiment, the same components as those of the first embodiment are denoted by the same reference numerals, and the detailed description thereof will be omitted, and different components from those of the first embodiment will be described.

As shown in FIG. 9, in the surface emitting device 50A according to this embodiment, a reflective sheet 55 is disposed so as to face the second main surface 1d as a reflecting member to reflect the light proceeding toward the second main surface 1d. The reference numeral 60 in FIG. 9 indicates a flexible printed circuit board which is disposed so as to face each light source 10A and 10B and involves in controlling the turning-on of the light sources 10A and 10B.

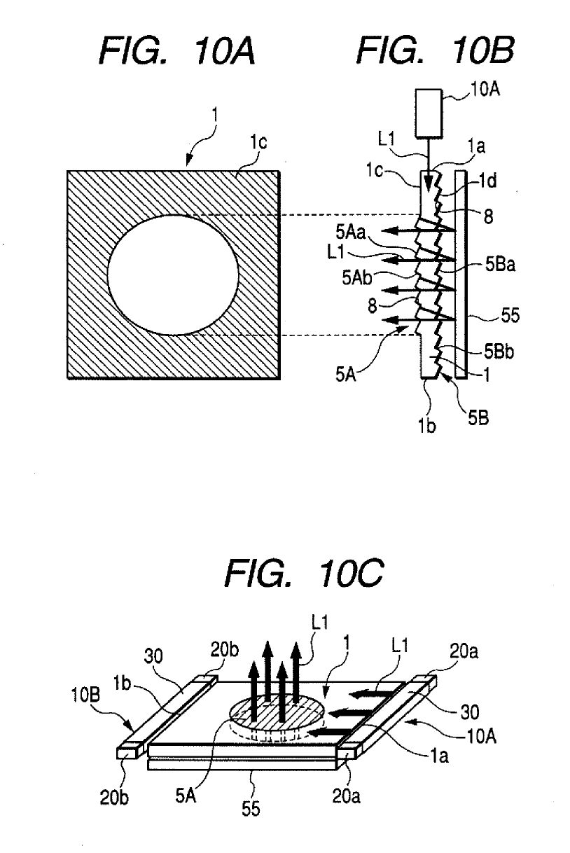

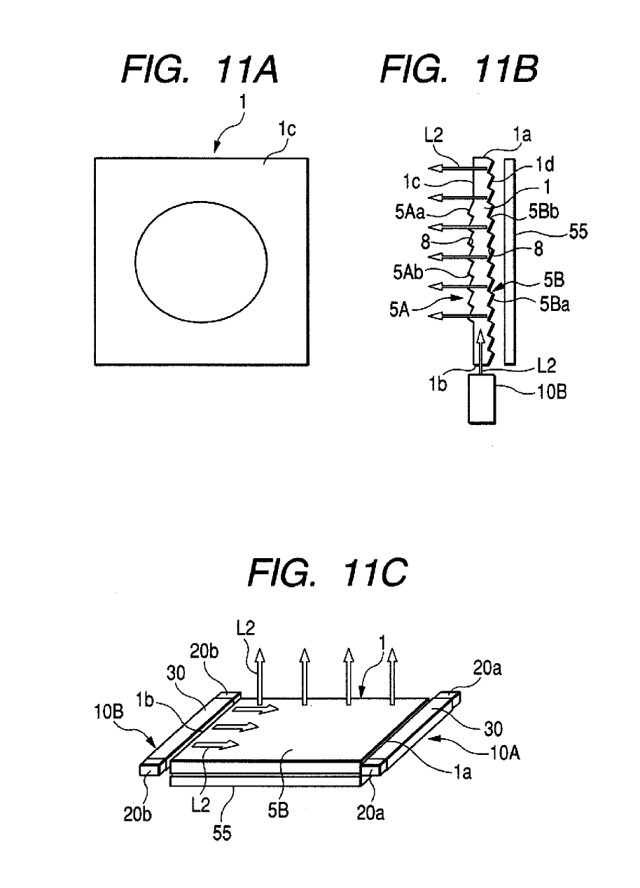

In this construction, in the same manner as the first embodiment, as one of the two light sources 10A and 10B is selectively turned on, the light from the prism 5A and 5B corresponding to the turned-on light source 10A and 10B is output toward the display surface. As the reflective sheet 55 reflects the light from the first or second prism 5A and 5B, the prism 5A and 5B outputs the light toward a common display surface, and the output light-irradiated regions on the display surface partially overlap each other or concentrically overlap each other. As shown in FIG. 10, when the first light source 10A is turned on, the light receiving surface 8 of the steep slope surface 5Ab of the first prism 5A formed on the first main surface 1c changes the optical path of the light L1 output from the first light source 10A so that the light proceeds toward the second main surface 1d and penetrates the gentle slope surface 5Bb of the second prism 5B, and then the reflective sheet 55 reflects the light to penetrate the gentle slope surface 5Ba and 5Aa of the second and first prism 5B and 5A. Therefore, when the light-emission pattern of the first prism 5A is seen from the first main surface 1d (for example, through the common display surface disposed so as to face the second main surface 1d), the pattern is seen as circular shape as shown in FIG. 10A.

Alternatively, as shown in FIG. 11, when the second light source 10B is turned on, the light receiving surface 8 of the steep slope surface 5Bb of the second prism 5B formed on the second main surface 1d changes the optical path of the light L2 output from the second light source 10B, so that the light proceeds toward the first main surface 1c and penetrates the gentle slope surface 5Aa of the first prism 5A. When the light-emission pattern of the second prism 5B is seen from the first main surface 1c (through the common surface disposed so as to face the first main surface 1c), the pattern is seen as if the entire surface emits light, regardless of its shape, as shown in FIG. 11A. When both light sources 10A and 10B are turned off, the display pattern, as seen from the first main surface 1c, becomes dark as shown in FIG. 4A.

According to this embodiment, the reflective sheet 55 is disposed so as to face the main surface to reflect light. As the reflective sheet 55 reflects the light from the first or second prism 5A or 5B, the first and second prisms 5A and 5B output light toward the common display surface, and the output light-irradiated regions on the display surface partially overlap each other. The light guide plate 1 can selectively perform a light-emission display of each prism 5A and 5B at one side of the light guide plate. The displayed pattern on the common display surface can be changed by switching between the light sources 10A and 10B. It is possible to easily and clearly display information without scattering information, which improves convenience of information. Since one light guide plate 1 can simply perform two kinds of light-emission display, multifaceted display is performed, and the entire thickness of the surface emitting device 50 is reduced.

According to this embodiment, the gentle slope surfaces 5Aa and 5Ba of the first and second prisms 5A and 5B are inclined by a predetermined angle such that the gentle slope surfaces 5Aa and 5Ba transmit a reflected light from the reflective sheet 55. Even though the reflective sheet 55 reflects the light from the first prism 5A toward the second prism 5B, the light-emission pattern of the first prism 5A is not affected by the second prism 5B. Even though the first and second prisms 5A and 5B are formed in one light guide plate 1 in this embodiment, it is possible to easily and clearly perform light-emission display of complex and delicate patterns of the prisms 5A and 5B.

According to this embodiment, the reflective sheet 55 can be arranged so as to face the first main surface 1c. In this case, the same display pattern as that of FIGS. 10A and 11A is seen at the second main surface 1d.

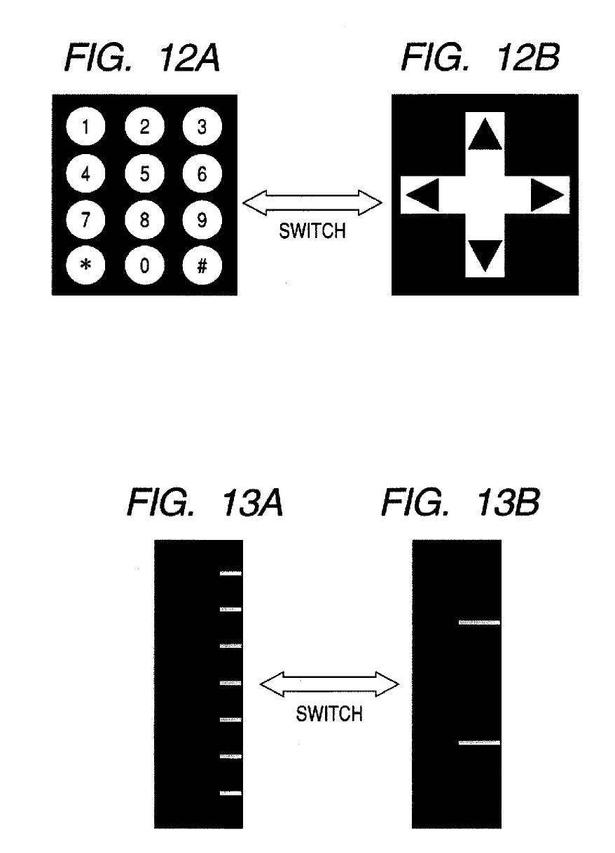

FIGS. 12 and 13 are views showing the second embodiment. For example, as shown in FIG. 12, the first prism 5A is formed in a concavo-convex shape to have a light-emission pattern of a numeric keypad as shown in FIG. 12A, while the second prism 5B is formed in a concave-convex shape to have a light-emission pattern of a cross keypad as shown in FIG. 12B. For example, as modes are switched in an instrument having the surface emitting device 50A mounted therein by selectively turning on the first and second light sources 10A and 10B, it is possible to switchably display a numeric keypad (FIG. 12A) and a cross keypad (FIG. 12B) at one of the first and second main surfaces 1c and 1d (for example, the common display surface disposed so as to face the first main surface 1c). In another example, a screen display of the numeric keypad can be used as a phone number input unit during telephone calling in a mobile phone or the like, and a screen display of the cross keypad can be used as a rewind button of a music player.

According to the application of FIG. 13, for example, the first prism 5A is formed in a concave-convex shape so as to have a light-emission pattern of a millimeter scale as shown in FIG. 13A. The second prism 5B is formed in a concave-convex shape so as to have a light-emission pattern of an inch scale as shown in FIG. 13B. For example, as modes are switched in an instrument having the surface emitting device 50A mounted therein by selectively turning on the first and second light sources 10A and 10B, it is possible to convertibly display the millimeter scale (FIG. 13A) and the inch scale (FIG. 13B) at one of the first and second main surfaces 1c and 1d (for example, the common display surface disposed so as to face the first main surface 1c).

In FIGS. 12 and 13, it is possible to make different emitting colors of each display screen from each other when the display screen is switched. This is achieved by differentiating the emitting color of the light sources 10A and 10B from each other.

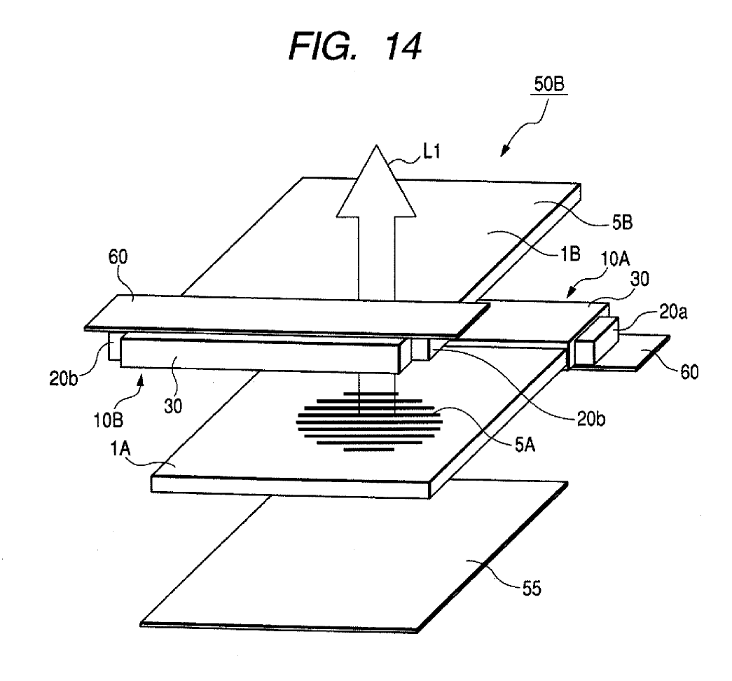

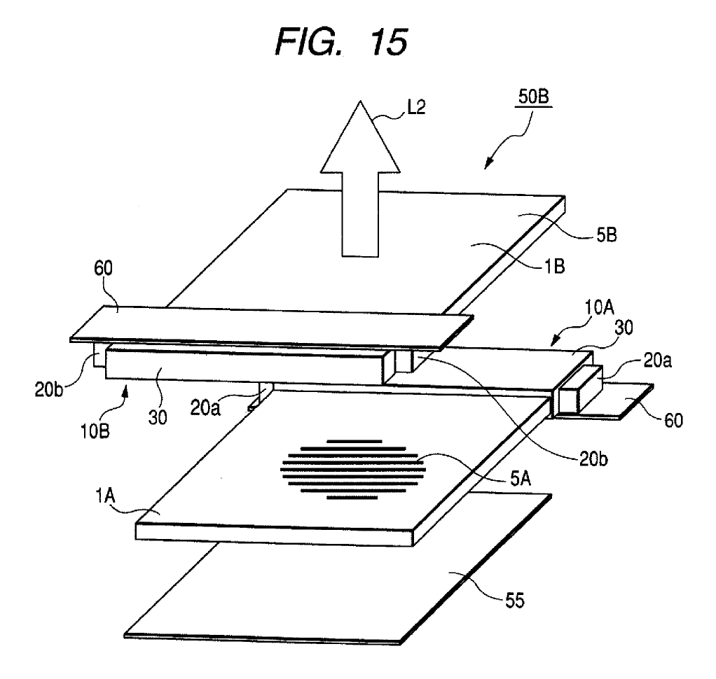

FIGS. 14 and 15 are views showing a third embodiment of this invention to which the principle of FIGS. 1 to 4 is applied. Since the third embodiment is a modification of the second embodiment, the same components as those of the second embodiment are denoted by the same reference numerals, and the detailed description thereof will be omitted, and different components from those of the second embodiment will be described.

As shown in FIGS. 14 and 15, in the surface emitting device 50B according to this embodiment, the light guide plate 1 of the second embodiment is divided into two light guide plates 1A and 1B. For example, the first light guide plate 1A receives light from the first light source 10A at the first end surface 1a, and has the first prism 5A, which changes the optical path of the light from the first light source 10A, on the first main surface 1c or the second main surface 1d. Alternatively, the second light guide plate 1B receives light from the second light source 10B at the second end surface 1b, and has the second prism 5B, which changes the optical path of the light from the second light source 10B, on the first main surface 1c or the second main surface 1d.

As shown in FIG. 14, when the first light source 10A is turned on, the light receiving surface 8 of the steep slope surface 5Ab of the first prism 5A formed on one main surface of the first light plate 1A changes the optical path of the light L1 output from the first light source 10A so that the light proceeds toward the other main surface and is reflected by the reflective sheet 55, or is not reflected and output toward the common display surface (not shown). When the light-emission pattern of the first prism 5A is seen from the common display surface, the light-emission pattern is seen as circular shape.

Alternatively, as shown in FIG. 15, when the second light source 10B is turned on, the light receiving surface 8 of the steep slope surface 5Bb of the second prism 5B formed on one main surface changes the optical path of the light L2 output from the second light source 10B so that the light proceeds toward the other main surface and is reflected by the reflective sheet 55, or is not reflected and output toward the common display surface (not shown). When the light-emission pattern of the second prism 5B is seen from the common display surface, the pattern is seen as if the entire surface emits light regardless of its shape. When both light sources 10A and 10B are turned off, as described above, the display pattern, as seen from the common display surface, becomes dark.

As described above, according to this embodiment, since one light guide plate 1A (1B) individually corresponds to one light source 10A (10B) and one prism 5A (5B), it is possible to make simple a manufacturing process, and clearly distinguish whether light comes from the light source 10A or the light source 10B, and release limitation on shape patterns of the prisms 5A and 5B, thereby achieving a prism pattern having a high degree of freedom.

In one embodiment, a surface emitting device includes a plurality of light sources. One or more light guide member which has an end surface that receives light from the light source and a pair of main surfaces face each other, and outputs the light received from the light source by the end surface through one of the mains surfaces toward a predetermined display surface. A plurality of prisms which are disposed on the main surface of the light guide member so as to respond to each light source, is formed of a convex-concave portion having a predetermined pattern, respectively, and changes the optical path of the light from the light source toward the display surface.

For example, as one of the light sources is selectively turned on, the light from the prism corresponding to the turned-on light source is output toward the display surface. It is possible to provide a small surface emitting device capable of selectively displaying various kinds of information on the same display surface, while reducing the size of the display region.

1. A surface emitting device comprising:
a plurality of light sources;
a light guide member having an end surface that receives light from the light sources and a pair of main surfaces that face each other, the light guide member operable to output light received from the light sources through the end surface from one of the main surfaces toward a predetermined display surface; and
a plurality of prisms that are disposed on the main surfaces and formed by convex-concave portions,
wherein the prisms are operable to change the optical path of light from the light sources toward the display surface, and
wherein the surface emitting device is operable to display only light from the prism corresponding to a turned-on light source.

2. The surface emitting device according to claim 1, wherein the light guide member includes:
a first end surface that receives light from a first light source,
a second end surface that is disposed to face the first end surface and receives light from a second light source,
a first main surface on which a first prism is disposed, and
a second main surface that is disposed to face the first main surface and on which a second prism is disposed,
wherein the first prism is operable to receive light from the first light source and change the optical path of light toward the second main surface, and the second prism is operable to receive light from the second light source and change the optical path of light toward the first main surface.

3. The surface emitting device according to claim 2,
wherein the first and second prisms have convex-concave portions that are formed in an inequilateral triangle.

4. The surface emitting device according to claim 3,
wherein the inequilateral triangle has a first slope portion and a second slope portion alternately disposed, the first slope portion being inclined at a predetermined first angle with respect to the main surface, and the second slope portion being inclined at a second angle larger than the first angle with respect to the main surface, and wherein the second slope portion is operable to receive light from the light source and change the optical path of light.

5. The surface emitting device according to claim 4,
wherein a light receiving surface of the second slope portion of the first prism faces the first end surface, and a light receiving surface of the second slope portion of the second prism faces the second end surface opposite to the light receiving surface of the second slope portion of the first prism.

6. The surface emitting device according to claim 2, further comprising:
a reflecting member that is disposed to face the first main surface or the second main surface,
wherein the reflecting member is operable to reflect light from the first or second prism, the first and second prisms being operable to output light toward a common display surface, and output light-irradiated regions on the display surface that partially overlap each other.

7. The surface emitting device according to claim 6,
wherein a slope angle of the first slope portion of the first or second prism is set such that the first slope portion transmits light reflected by the reflecting member.

8. The surface emitting device according to claim 1,
wherein the light guide member has a first light guide member and a second light guide member,
the first light guide member is operable to receive light from the first light source at the end surface, and having the first prism that changes the optical path of light from the first light source, and
the second light guide member is operable receive light from the second light source at the end surface, and having the second prism that changes the optical path of light from the second light source.

9. The surface emitting device according to claim 2,
wherein the first light source emits a predetermined first color, and the second light source emits at least one color other than the first color.
